(19) United States
(12) Patent Application Publication
(10) Pub. No.: US 2016/0131045 A1
(43) Pub. Date: May 12, 2016

(54) EMISSIONS CONTROL SYSTEM FOR A GAS TURBINE ENGINE

(71) Applicant: Siemens Energy, Inc., Orlando, FL (US)

(72) Inventors: Miguel Bascones, Oviedo, FL (US); Michael H. Koenig, Oviedo, FL (US); Weidong Cai, Oviedo, FL (US); Mrinal Munshi, Orlando, FL (US); Vinayak V. Barve, Oviedo, FL (US)

(21) Appl. No.: 14/538,867

(22) Filed: Nov. 12, 2014

(51) Int. Cl. F02C 9/18; F02C 3/30

(52) U.S. Cl. CPC F02C 9/18; F02C 3/30; F05D 2220/32; F05D 2270/08; F05D 2240/55

(57) ABSTRACT

An emissions control system (10) for a gas turbine engine (12) for reducing CO emissions at partial load of the gas turbine engine (12) is disclosed. In at least one embodiment, the emissions control system (10) may be formed from one or more compressed air exhausts (14) for exhausting compressed air into a hot gas pathway contained within a channel (18) formed by a transition (20) extending from a combustor (22) to a turbine assembly (24). In at least one embodiment, a plurality of seals (26) may extend circumferentially around the transition (20) providing a seal (26) between the transition (20) and a component of a downstream turbine assembly (24). One or more compressed air exhausts (14) may be positioned between adjacent seals (26). The compressed air exhausts (14) may be, but are not limited to being, channels (30), orifices (34) and metered spaces (32) having various shapes and configurations.

### FIELD OF THE INVENTION

This invention is directed generally to emission control systems and, more particularly, to systems configured to inject air into hot has pathways downstream of combustors in gas turbine engines to reduce CO emissions.

### BACKGROUND

Turbine engines typically combust a mixture of fuel and air in a combustion chamber and pass the exhaust gases produced in the combustion chamber through a turbine vane assembly to drive the turbine assembly. Typically, a plurality of transitions couple a combustor to a turbine vane assembly in a can-annular system. During operation of a turbine engine, exhaust gases flow through the transitions and into the turbine vane assemblies. When gas turbine engines operate at a partial or reduced load, the low part load conditions typically create excessive carbon oxides (CO) emissions with some base load NOx margin. Such excessive CO emissions have been addressed by injecting air into the hot gas pathway under certain engine conditions. However, these systems were costly, required excessive maintenance and had poor structural integrity. Thus, a need exists for a more robust system for reducing CO emissions a partial loads of the gas turbine engine.

### SUMMARY OF THE INVENTION

An emissions control system for a gas turbine engine for reducing CO emissions at partial load of the gas turbine engine is disclosed. In at least one embodiment, the emissions control system may be formed from one or more compressed air exhausts for exhausting compressed air into a hot gas pathway contained within a channel formed by a transition extending from a combustor to a turbine assembly. In at least one embodiment, a plurality of seals may extend circumferentially around the transition providing a seal between the transition and a component of a downstream turbine assembly. The seals may be configured to induce controlled leakage past the seal to better control emissions of the gas turbine engine. One or more compressed air exhausts may be positioned between adjacent seals to control the leakage. One or more compressed air exhausts may be positioned between adjacent seals. The compressed air exhausts may be, but are not limited to being, channels, orifices and metered spaces having various shapes and configurations.

In at least one embodiment, the emissions control system for a gas turbine engine may include one or more transitions forming a channel extending from a combustor to a turbine assembly and one or more seals coupling the transition to a component of the turbine assembly. The seal may include one or more compressed air exhausts for exhausting compressed air into a hot gas pathway contained within the channel formed by the transition. The compressed air exhaust may be formed from one or more orifices in a body of the seal. In at least one embodiment, the body of the seal may be formed from a plurality of orifices. The plurality of orifices may be spaced equidistant from each other or in another configuration.

In at least one embodiment, the seal may be formed from a plurality of seals extending circumferentially around the transition. The compressed air exhaust may be positioned between adjacent seals. In at least one embodiment, one or more compressed air exhausts may be positioned between each of the plurality of seals. The compressed air exhausts may be formed from channels or metered spaces. In at least one embodiment, the compressed air exhaust may be formed from a plurality of channels or metered spaces. In another embodiment, the compressed air exhaust may be formed from one or more orifices in a body of each of the plurality of seals. The orifice in the body of each seal may be formed from a plurality of orifices. In at least one embodiment, the orifices may be spaced equidistant from each other. The orifices may have any appropriate shape, such as, but not limited to, circular, elliptical, oval, polygon and others.

The emissions control system may include one or more compressed air exhausts having one or more inlets in fluid communication with a compressed air source. The compressed air exhaust may have one or more inlets in fluid communication with one or more compressed air chambers formed by at least one casing forming a compressed air source for the combustor, whereby the casing may forming the compressed air source may surround the combustor.

During operation of a turbine engine in which the emission control system is contained, air, such as but limited to, compressed air, may be supplied to the hot gas pathway via the emissions control system to reduce the CO levels during turbine engine operation, which his especially a problem during partial load operating conditions. The emission control system may provide air through one or more channels, orifices and metered spaces having one or more various shapes and configurations to reduce CO levels during turbine engine operation.

An advantage of the emission control system is that the system uses transition seals to achieve improved turndown capability via one or more channels, orifices, metered spaces or the like to inject air into the hot gas pathway in the transition without suffering from the drawbacks of convention systems including high costs, high maintenance and poor mechanical integrity of the transition.

Another advantage of the emission control system is that the system These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a partial cross-sectional, perspective view of a gas turbine engine with the emissions control system.

FIG. 2 is a cross-sectional view of the combustion system together with the emissions control system taken along section line 2-2 in FIG. 1.

FIG. 3 is a perspective view of a seal of the emissions control system.

FIG. 4 is another perspective view of a seal of the emissions control system.

FIG. 5 is a cross-sectional detail view of a seal positioned between a transition and a component of the turbine assembly, taken at detail line 5-5 in FIG. 2.

FIG. 6 is a perspective view of another embodiment of a seal of the emissions control system.

FIG. 7 is a perspective view of yet another embodiment of a seal of the emissions control system.

FIG. 8 is a cross-sectional detail view of a seal positioned between a transition and a component of the turbine assembly, taken at detail line 5-5 in FIG. 2.

### DETAILED DESCRIPTION OF THE INVENTION

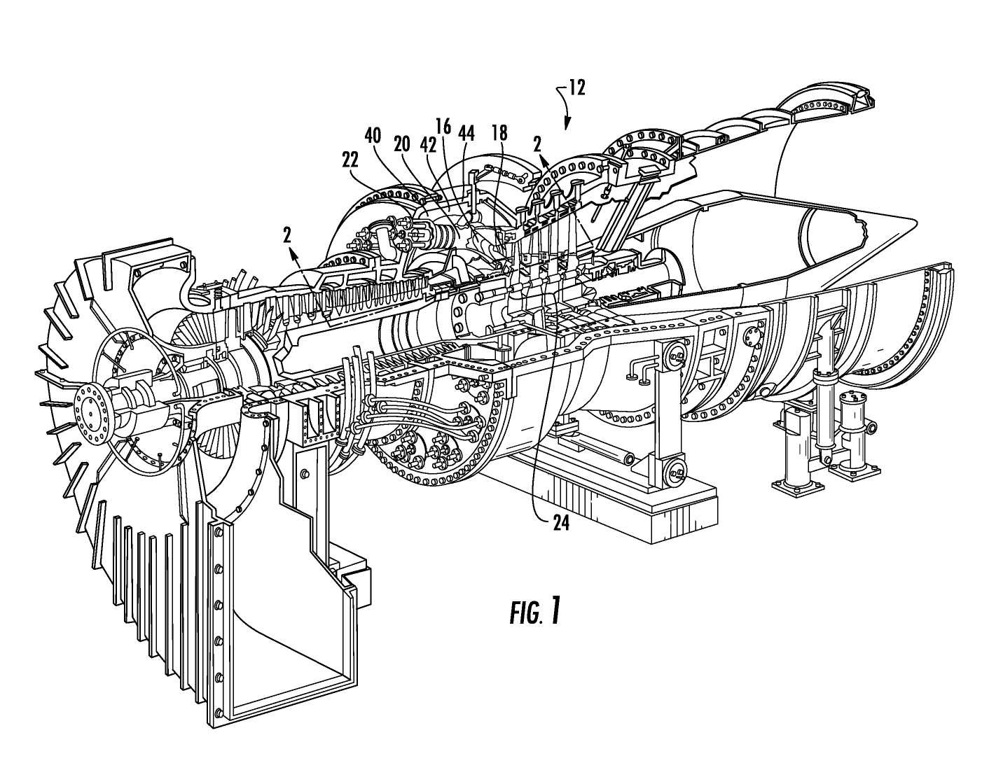

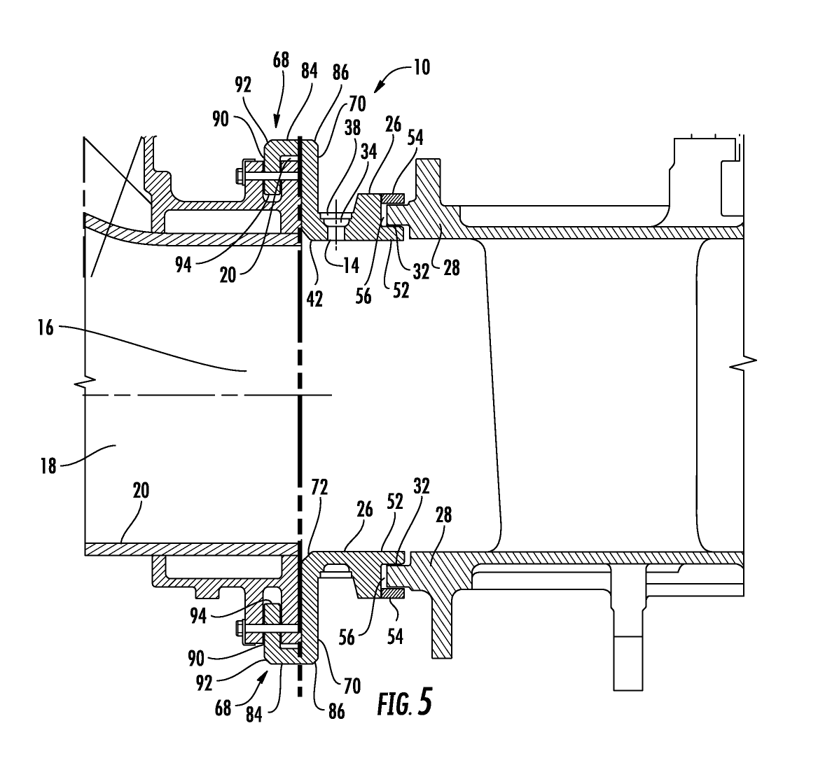

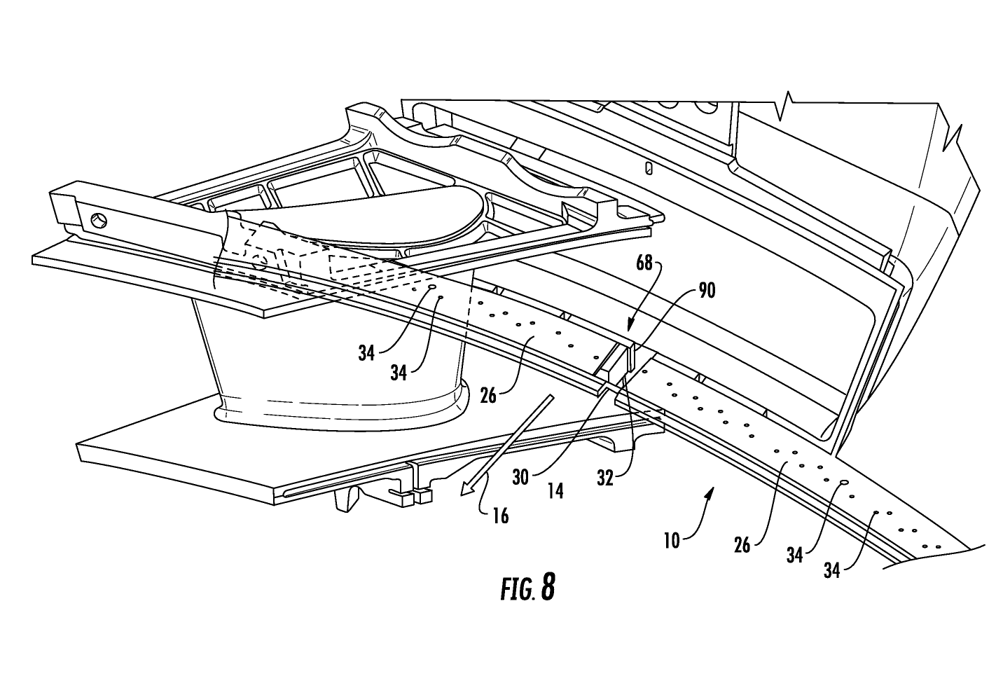

As shown in FIGS. 1-8, an emissions control system 10 for a gas turbine engine 12 for reducing CO emissions at partial load of the gas turbine engine 12 is disclosed. In at least one embodiment, the emissions control system 10 may be formed from one or more compressed air exhausts 14 for exhausting compressed air into a hot gas pathway 16 contained within a channel 18 formed by a transition 20 extending from a combustor 22 to a turbine assembly 24. In at least one embodiment, a plurality of seals 26 may extend circumferentially around the transition 20 providing a seal between the transition 20 and a component 28 of a downstream turbine assembly 26. The seals 26 may be configured to induce controlled leakage past the seal 26 to better control emissions of the gas turbine engine 12. One or more compressed air exhausts 14 may be positioned between adjacent seals 26 to control the leakage. The compressed air exhausts 14 may be, but are not limited to being, channels 30, orifices 34 and metered spaces 32 having various shapes and configurations.

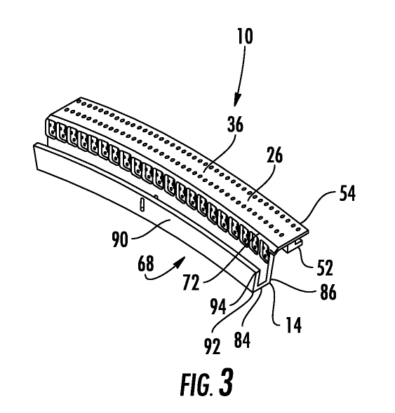

In at least one embodiment, the emissions control system 10 for a gas turbine engine 12 may include one or more transitions 20 forming a channel 18 extending from a combustor 22 to a turbine assembly 24. One or more seals 26 may couple the transition 20 to a component 28 of the turbine assembly 24. The seal 26 may have any appropriate configuration. In at least one embodiment, as shown in FIGS. 3-8, the seal 26 may be formed from a curvilinear body 36 extending at least partially circumferentially and one or more hot lips 52 extending axially from the elongated body 36. The seal 26 may also include one or more cold lips 54 coupled to the elongated body 36 radially inward of the hot lip 52 and extending axially from the elongated body 36 to form a receiving cavity 56 between the hot lip 52 and the cold lip 54. A radially outer surface 30 of the cold lip 54 may be generally aligned with a radially inner surface 62 of the hot lip 52. The hot lip 52 may be integrally formed with the elongated body 36 or may be a separate component attached to the elongated body 36. The hot lip 52 may have a generally linear outer surface 64 in an axial direction, which may also be curved in a circumferential direction.

The elongated body 36 may also include a hook 68 formed from a radially extending shank arm 70 extending from an axial end 72 of the elongated body 36 opposite to the hot lip 52. The hook 68 may include an axially extending throat 84 extending axially from a radially inner end 86 of the radially extending shank arm 80. The radially extending hook arm 90 may extend radially outward from an end 92 of the axially extending throat 84 opposite to the end 94 to which the radially extending shank arm 80 is attached. The radially extending hook arm 90 may be shorter in length than the radially extending shank arm 80. In at least one embodiment, the cold lip 54 may be formed from a HAYNES 25 material or other appropriate material.

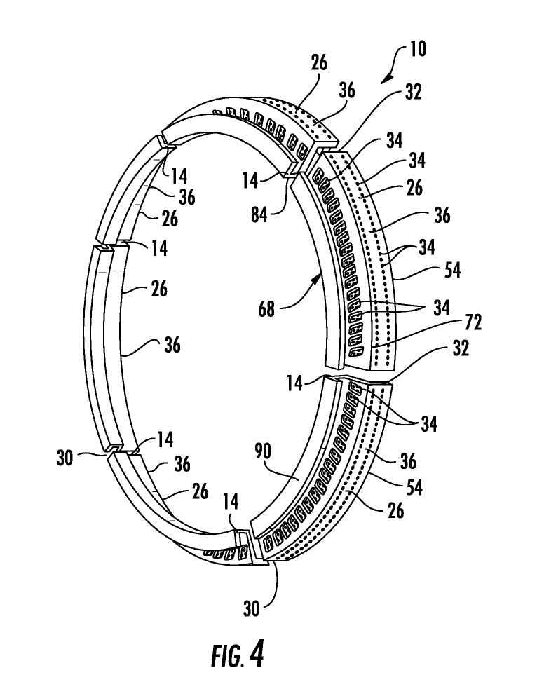

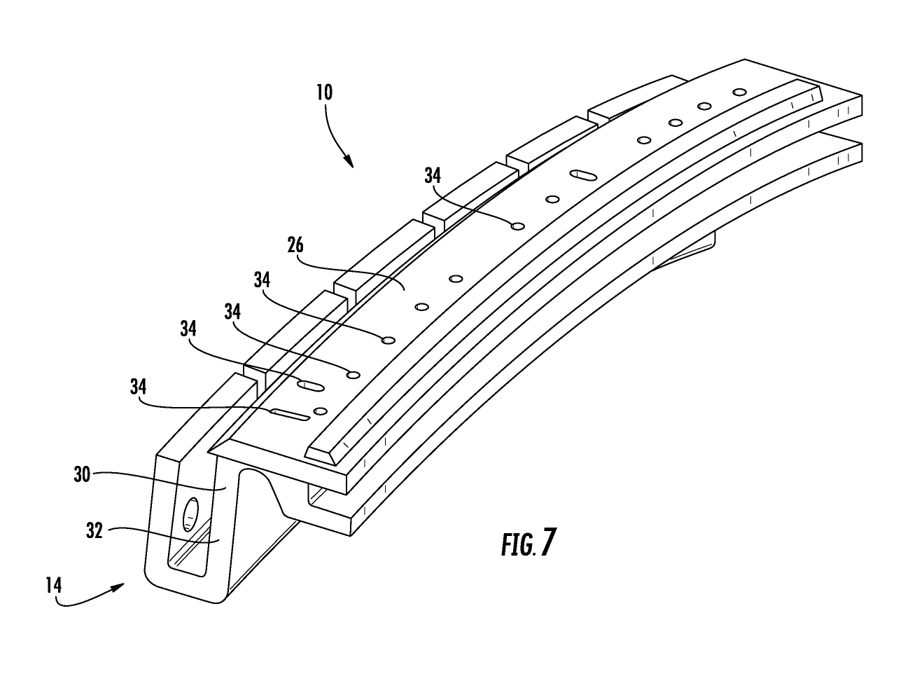

The seal 26 may include one or more compressed air exhausts 14 for exhausting compressed air into the hot gas pathway 16 contained within the channel 18 formed by the transition 20. In at least one embodiment, the seal 26 may be formed from a plurality of seals 26 extending circumferentially around the transition 20. One or more compressed air exhaust 14 may be positioned between one or more adjacent seals 26. In at least one embodiment, as shown in FIG. 4, the compressed air exhaust 14 may be positioned between each of the plurality of seals 26. The compressed air exhaust 14 may be formed from channels 30 or metered spaces 32, as shown in FIGS. 4 and 6-8. In at least one embodiment, as shown in FIGS. 4, 7 and 8, the compressed air exhaust 14 may be formed from a plurality of channels 30 or metered spaces 32. In another embodiment, as shown in FIG. 7, passages, such as metered spaces 32, may be used instead of or in addition to holes in the seal 26 in any combination to controlled the flow of air past the seal 26 from the cold side to the hot side with the purpose of controlling CO emissions.

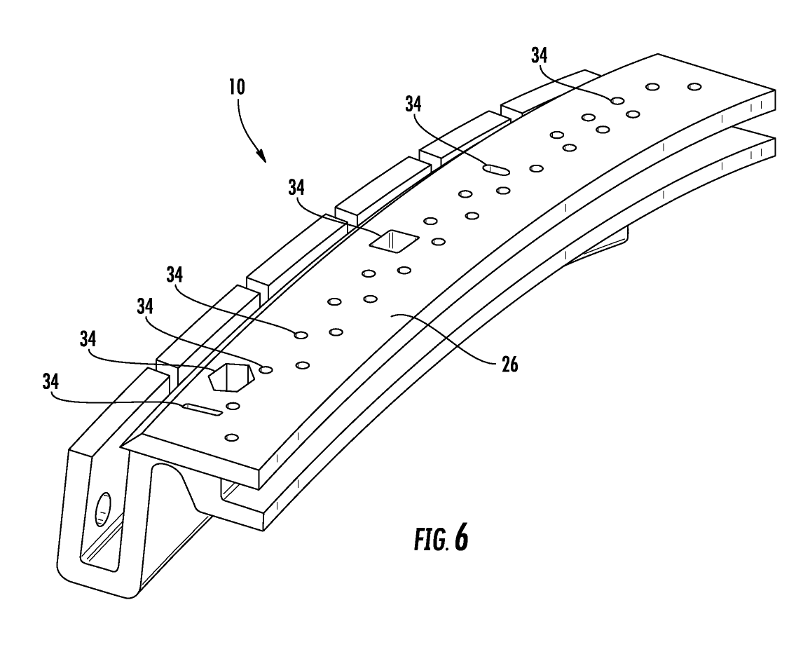

In at least one embodiment, the compressed air exhaust 14 may be formed from one or more orifices 34 in a body 36 of the seal 26, as shown in FIGS. 4 and 6. In at least one embodiment, the body 36 of the seal 26 may include a plurality of orifices 34. The orifices 34 may be spaced equidistant from each other, in another pattern, randomly or any combination thereof. The orifices 34 may have any appropriate shape, such as, but not limited to, circular, elliptical, oval, polygon and others. In another embodiment, each of the bodies 36 of the seal 26 forming a ring around the transition 20 may include a plurality of orifices 34. The compressed air exhaust 14 may be formed from any number of orifices 34 in any combination to controlled the flow of air past the seal 26 from the cold side to the hot side with the purpose of controlling carbon dioxide (CO) emissions, as shown in FIG. 6. The orifices 34 may have any size, configuration or number to create the desired flow.

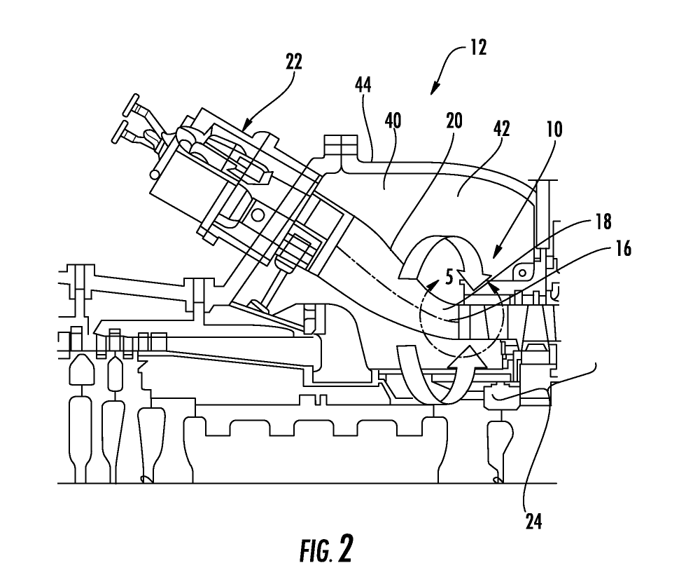

The emissions control system may be configured such the compressed air exhaust 14 may have one or more inlets 38 in fluid communication with a compressed air source 40, as shown in FIGS. 1 and 2. The compressed air exhaust 14 may have one or more inlets 38 in fluid communication with one or more compressed air chambers 42 formed by at least one casing 44 forming a compressed air source 40 for the combustor 22. The casing 44 forming the compressed air source 40 may surround the combustor 22.

During operation of a turbine engine 12 in which the emission control system 10 is contained, air, such as but limited to, compressed air, may be supplied to the hot gas pathway 16 via the emissions control system 10 to reduce the CO levels during turbine engine operation, which his especially a problem during partial load operating conditions. The emission control system 10 may provide air through one or more channels 30, orifices 34 and metered spaces 32 having one or more various shapes and configurations to reduce CO levels during turbine engine operation.

The foregoing is provided for purposes of illustrating, explaining, and describing embodiments of this invention. Modifications and adaptations to these embodiments will be apparent to those skilled in the art and may be made without departing from the scope or spirit of this invention.

We claim:

1. An emissions control system (10) for a gas turbine engine (12), characterized in that:
at least one transition (20) forming a channel (18) extending from a combustor (22) to a turbine assembly (24);
at least one seal (26) coupling the at least one transition (20) to a component of the turbine assembly (24); and
wherein the at least one seal (26) includes at least one compressed air exhaust (14) for exhausting compressed air into a hot gas pathway contained within the channel (18) formed by the at least one transition (20).

2. The emissions control system (10) of claim 1, characterized in that the at least one compressed air exhaust (14) is formed from at least one orifice (34) in a body (36) of the at least one seal (26).

3. The emissions control system (10) of claim 2, characterized in that the at least one orifice (34) in the body (36) of the at least one seal (26) is formed from a plurality of orifices (34).

4. The emissions control system (10) of claim 2, characterized in that the plurality of orifices (34) are spaced equidistant from each other.

5. The emissions control system (10) of claim 1, characterized in that the at least one seal (26) comprises a plurality of seals (26) extending circumferentially around the at least one transition (20) and wherein the at least one compressed air exhaust (14) is positioned between adjacent seals (26).

6. The emissions control system (10) of claim 5, characterized in that at least one compressed air exhaust (14) is positioned between each of the plurality of seals (26).

7. The emissions control system (10) of claim 5, characterized in that the at least one compressed air exhaust (14) is formed from at least one orifice (34) in a body (36) of each of the plurality of seals (26).

8. The emissions control system (10) of claim 7, characterized in that the at least one orifice (34) in the body (36) of each seal (26) is formed from a plurality of orifices (34).

9. The emissions control system (10) of claim 7, characterized in that the plurality of orifices (34) are spaced equidistant from each other.

10. The emissions control system (10) of claim 1, characterized in that the at least one compressed air exhaust (14) has at least one inlet in fluid communication with a compressed air source (40).

11. The emissions control system (10) of claim 1, characterized in that the at least one compressed air exhaust (14) has at least one inlet (38) in fluid communication with at least one compressed air chamber (42) formed by at least one casing (44) forming a compressed air source (40) for the combustor (22) and wherein the at least one casing (44) forming compressed air source (40) surrounds the combustor (22).
